(19) United States
(12) Patent Application Publication
(10) Pub. No.: US 2018/0004629 A1
(43) Pub. Date: Jan. 4, 2018

(54) RUN TIME SMF/RMF STATISTICAL FORMULA METHODOLOGY FOR GENERATING ENHANCED WORKLOAD DATA POINTS FOR CUSTOMER PROFILING VISUALIZATION

(71) Applicant: International Business Machines Corporation, Armonk, NY (US)

(72) Inventors: Thomas W. Conti, Poughkeepsie, NY (US); Terri A. Menendez, Richmond, MA (US); Kyle R. Moser, Stone Ridge, NY (US)

(21) Appl. No.: 15/197,844

(22) Filed: Jun. 30, 2016

(51) Int. Cl. G06F 11/36

(52) U.S. Cl. CPC G06F 11/3664; G06F 11/3692

(57) ABSTRACT

Aspects of the present invention include a method, system and computer program product for generating new or additional workload data points in accordance with one or more embodiments of the present invention. The method includes determining, by a processor, at least one workload data point, and determining, by the processor, a formula to utilize to operate on the at least one workload data point. The method also includes operating, by the processor, on the at least one workload data point using the determined formula to create one of a new or additional workload data point to be utilized in a test workload run that compares test workload run data with customer workload data.

### BACKGROUND

The present invention relates to the testing of software, and more specifically, to a method, system and computer program product that implement aspects of workload and operational profiling, thereby resulting in improvements in the testing of customer software.

In the field of software testing, as in many other technical fields, improvements are constantly being sought, primarily for cost and accuracy reasons. A fundamental goal of software testing in theory is to identify all of the problems in a customer's software program before the program is released for use by the customer. However, in reality this is far from the case as typically a software program is released to the customer having some number of problems that were unidentified during the software development and testing process.

A relatively more proactive approach to improving software testing is sought that employs traditional methods of understanding characteristics of clients' environments, augmented with a process of data mining empirical systems data. Such client environment and workload profiling analysis may result in software test improvements based on characteristics comparisons between the client and the test environments.

### SUMMARY

According to one or more embodiments of the present invention, a computer-implemented method includes determining, by a processor, at least one workload data point, and determining, by the processor, a formula to utilize to operate on the at least one workload data point. The method also includes operating, by the processor, on the at least one workload data point using the determined formula to create one of a new or additional workload data point to be utilized in a test workload run that compares test workload run data with customer workload data.

According to another embodiment of the present invention, a system includes a processor in communication with one or more types of memory, the processor configured to determine at least one workload data point, and to determine a formula to utilize to operate on the at least one workload data point. The processor is also configured to operate on the at least one workload data point using the determined formula to create one of a new or additional workload data point to be utilized in a test workload run that compares test workload run data with customer workload data.

According to yet another embodiment of the present invention, a computer program product includes a non-transitory storage medium readable by a processing circuit and storing instructions for execution by the processing circuit for performing a method that includes determining, by a processor, at least one workload data point, and determining, by the processor, a formula to utilize to operate on the at least one workload data point. The method also includes operating, by the processor, on the at least one workload data point using the determined formula to create one of a new or additional workload data point to be utilized in a test workload run that compares test workload run data with customer workload data.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 is a block diagram illustrating one example of a processing system for practice of the teachings herein; and

FIG. 4 is a flow diagram of a method for generating new or additional workload data points in accordance with one or more embodiments of the present invention.

### DETAILED DESCRIPTION

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

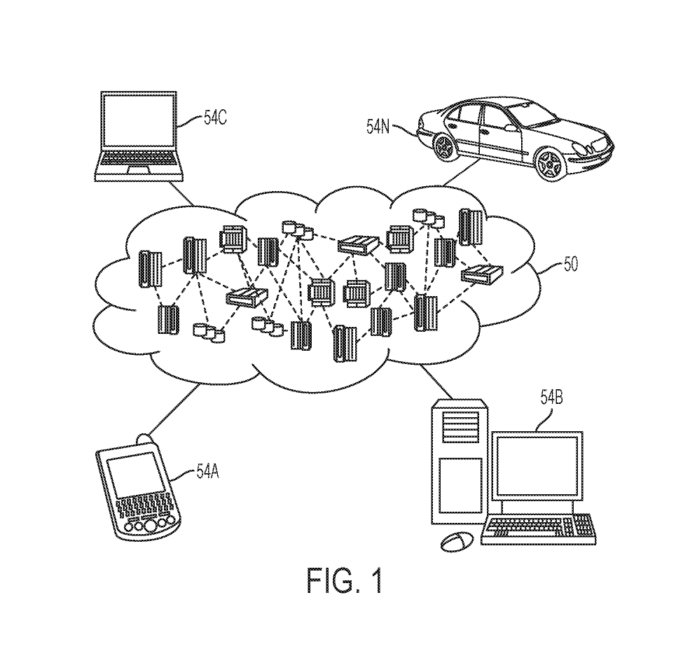

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

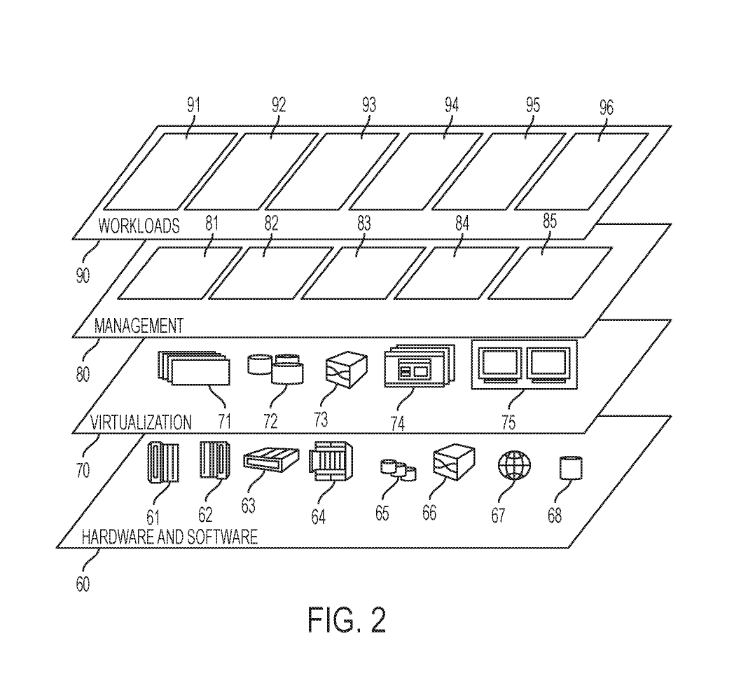

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and a method 96 for generating new or additional workload data points in accordance with one or more embodiments of the present invention.

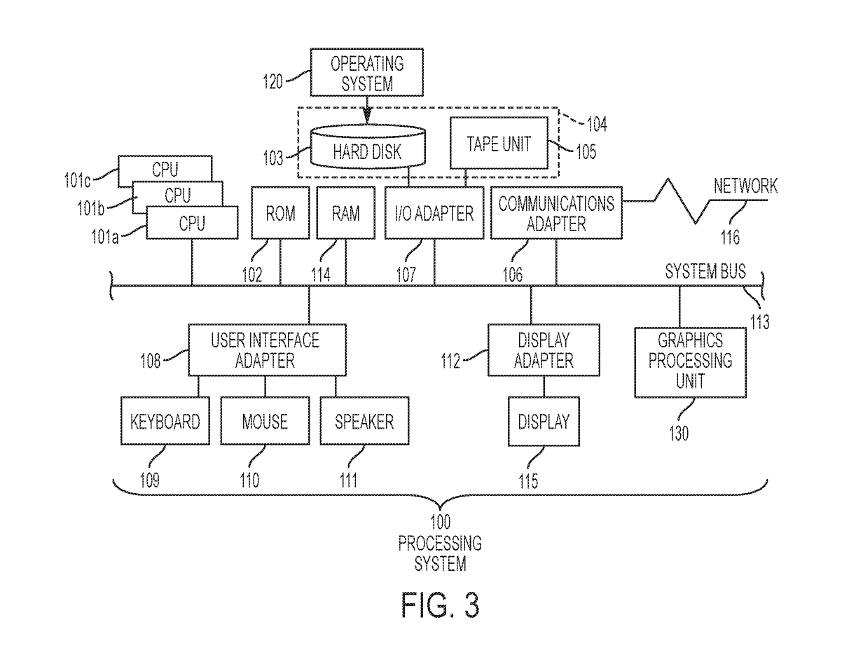

Referring to FIG. 3, there is shown a processing system 100 for implementing the teachings herein according to one or more embodiments. The system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 3 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 3, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 3.

In accordance with one or more embodiments of the present invention, methods, systems, and computer program products are disclosed for generating new or additional workload data points.

In the area of software testing, individual data points relating to records of activity (e.g., SMF or system management facility) or performance activity (e.g., RMF or resource management facility) within the software system may not always provide the level of complexity and insight needed for proper run time or historical customer and test workload comparisons and analysis. Also, test workload comparison requirements can vary widely between workload runs, and may oftentimes be dynamic in nature. As used herein, the term “workload” includes not only software but also hardware and firmware.

Thus, one or more embodiments of the present invention utilize a run time mathematical/statistical formula methodology to calculate or determine the appropriate additional or enhanced workload data points, wherein these added data points can provide the required level of information and intelligence needed for proper customer and test workload comparisons and analysis. Not only do embodiments contemplate “test-to customer” workload comparisons, they also contemplate “test to test” and “customer to customer” workload comparisons.

The run time statistical formula methodology of embodiments of the present invention helps to provide a deeper, more complex understanding of a test workload in comparison to one or more customer profiling workloads, in a time sensitive manner, and with minimal to no human intervention/assistance required during workload execution. Such embodiments of a run time formula methodology for test and customer profiling workloads provides benefits by significantly decreasing the amount of enhanced workload assessment time and appropriate tuning time to close to run time (possibly in minutes), as opposed to possibly delayed/significant time later in the workload run (potentially hours or even days), or even after the test workload run has completed.

Also, having a run time statistical formula methodology (with the capability to be specified by the test user prior to, at the start of, and/or during the test workload execution) provides a significantly greater degree of flexibility and insight that may be required to optimize any variety of customer workload comparison runs.

The methodology to create additional run time and historical data points in accordance with embodiments of the present invention provides the capability to supplement existing product functionality with data points that may not yet be incorporated into a system management facility, unable to be incorporated into the system management facility given resource constraints, and/or even considered as system management facility data points until now.

The run-time calculated statistical data points may comprise pre-defined (database stored) and/or user defined formulas for the current test workload execution. These formulas may range from simple mathematical equations (e.g., sums, percentages, variable weighting, etc.) to relatively more complex equations designed to delve from modestly to significantly deeper into the workload characteristics, thereby providing multi-factor/combinatorial/component relationship, analytics, and modeling data input.

Given that test workload runs can be inherently complicated, resource and time intensive, limited in availability, and financially expensive to configure, stage, run, and analyze, and can span multiple days or even weeks (including non-user monitored off-shift and weekend time), providing as in-depth as possible a view of the test workload in relation to the customer workload(s) through enhanced key workload indicators may result in relatively much more cost effective use.

In accordance with embodiments of the present invention, the run time statistical formula methodology for enhanced workload data relationships and insight provides multiple capabilities, efficiencies, and financial benefits for the test user/operator including helping to understand the run time effectiveness of the workload run (software, hardware, firmware) and what corrective run time adjustments may be required. Another benefit is to manually or automatically tune test workloads much closer to their intended goal through the very nature of faster, run time notification and awareness. Intended goals may include emulating key characteristics of a customer workload environment or a test recreation or replication. Additional benefits include significantly reducing the amount of limited and high value systems, storage, network, environmental, and personnel time and resources to accomplish test objectives, resulting in both financial savings and reduced environmental impact. Further benefits include increasing test plan efficiency through expanded test coverage, resulting in enhanced product quality and greater customer satisfaction. By the reduction of repeat test workload runs through higher individual workload run effectiveness, the test user/operator can run additional and/or expanded test cases/scenarios, and ensure each workload run maximizes a successful outcome. This also provides the opportunity to increase functional coverage.

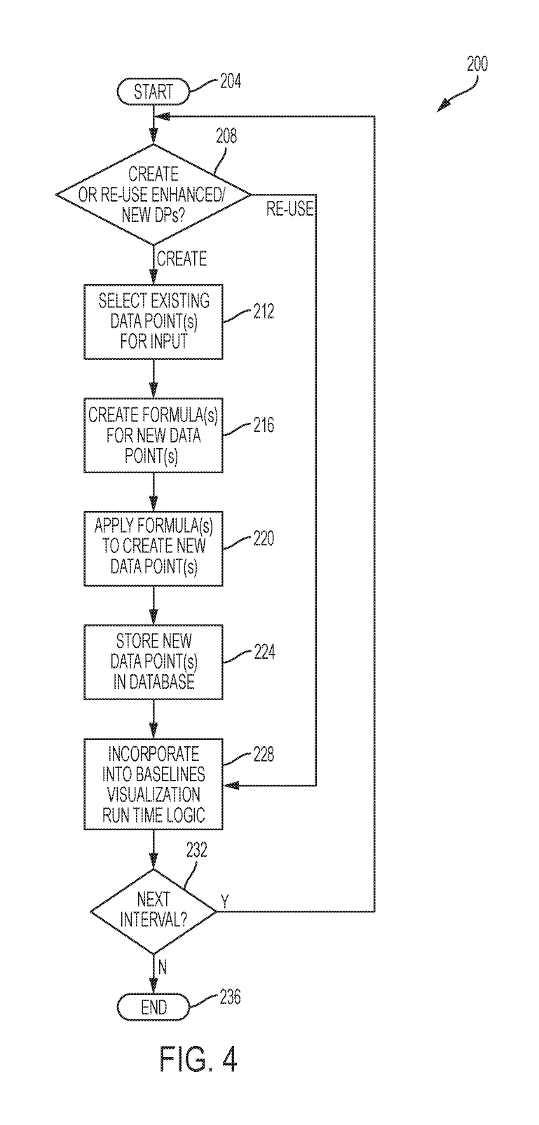

Referring now to FIG. 4, a flow diagram illustrates a method 200 according to one or more embodiments of the present invention for generating additional workload data points.

In one or more embodiments of the present invention, the method 200 may be embodied in software that is executed by computer elements located within a network that may reside in the cloud, such as the cloud computing environment 50 described hereinabove and illustrated in FIGS. 1 and 2. In other embodiments, the computer elements may reside on a computer system or processing system, such as the processing system 100 described hereinabove and illustrated in FIG. 3, or in some other type of computing or processing environment.

After a starting operation in a block 204, a block 208 comprises an operation in which a check is performed to see if the desired enhanced workload data points already exist (e.g., are stored in a database or other memory). If so, the method 200 branches to a block 228 whose operation is described in greater detail hereinafter.

If there are insufficient existing workload data points as a result of the check operation 208, then the method executes an operation in a block 212 in which one or more existing workload data points are selected for input into the statistical formulas in the method 200 of embodiments of the present invention.

In an operation in a block 216, these one or more statistical formulas may be determined, created or chosen. The formulas are determined, created or chosen depending on the new or additional workload data points that are desired to be created. A range of from simple formulas (e.g., ones that calculate or determine sums, averages, percentages, etc.) to relatively more complex statistical formulas may be utilized in this operation of the block 216.

With existing or created system management facility and/or resource management facility data points and technical subject matter expertise (“SME”) as input to the statistical formulas, an operation in a block 220 is performed to calculate the new and/or additional workload data points. The new/added data points provide greater insight and enhanced relationships and understanding of the targeted software system functional areas at customer profiling and test workload comparison run time. The new or added data points may then be stored in a database or other type of memory in an operation in a block 224.

If desired, an operation in a block 228 may be performed in which a customer profiling baselines visualization may utilize the new or added data points created in the block 220, together with existing customer data coupled with the live collection of test data during the test run. All of this data may be stored in a database or in some other type of memory. The data may be used in a web application to visually represent to the user or operator the levels of load and stress and ratios of activity for sets of related data points. As an additional, integrated feature of this web application, the run time statistical formula methodology of embodiments of the present invention may provide deeper levels of insight into the workloads' characteristics, which can be used for enhanced and expanded workload ion various areas—for example, in manual or automatic tuning, report scores, threshold alerts, playback of individual data points relating to records of activity or performance activity within the software system (e.g., SMF/RMF playback), test workload execution modeling, and business analytics to determine test workload effectiveness.

The method 200 then checks in an operation in block 232 if another test interval is desired to be run. If so, the method 200 branches back to the operation 208 that checks if new workload data points should be created or is existing workload data points should be used. If not, the method 200 ends in the block 236.

As with the standard/pre-existing data points relating to records of activity or performance activity within the software system, the run time statistical formula calculated data points may be stored in the customer profiling baselines visualization database and can be retrieved for later comparisons of customer profiling and/or test workloads.

The functionality provided by the method 200 of embodiments of the present invention provides additional insight and intelligence for targeted workload run components in comparison to a wide range of historical customer workload data, as specified by the test workload user or operator.

As an additional, integrated feature of a customer profiling baselines visualization web application function, a run time statistical formula methodology may provide relatively deeper levels of insight into the workloads' characteristics, which can be used for an enhanced and expanded test workload.

The run-time calculated or determined statistical data points may comprise pre-defined (database stored) and/or user defined formulas for the current test workload execution. These formulas may range from simple mathematical equations (such as, sums, percentages, variable weighting) to relatively much more complex equations designed to delve modestly to significantly deeper into (i.e., take into account) the test workload characteristics, providing multi-factor/combinatorial/component relationship, analytics, and modeling data input.

In addition to providing the stand-alone benefit of greater technical workload insight and intelligence, these enhanced data points may supplement and be integrated into several other customer profiling visualization technical applications. For example, run time score retention, supplemented with the statistical formula data points, in the customer profiling baselines visualization database, may provide expanded analytics on the consistency, variability, scalability, availability, reliability and other expected and unexpected behaviors of individual and collective workload runs.

Also, run-time workload threshold alerts can be enhanced using these statistical formula data points, providing greater alert capabilities and corresponding manual or automated tuning actions. Further, with enhanced insight derived from the statistical formula data points, automatic workload tuning can likewise be enhanced to address more complex workload conditions and characteristics. This results in test workloads execution that is relatively closer to the customer profiling workload (i.e., more “customer-like”).

As discussed hereinabove, a range of from simple to complex statistical formula data points can be used to supplement the standard system management facility or resource measurement facility workload data web dashboard playback. This provides for relatively greater customer and test workloads insight. These statistical formula data points can be presented in a variety of methods, including an integrated display of the customer and test workload comparison standard system management facility or resource measurement facility data points, as a separate playback consisting of only these statistical formula data points, and other flexible configurations.

In addition, through the use of the additional simple to complex statistical formula workload data points, more complex test workload execution modeling can be performed, resulting in modest to significantly greater customer and test workload understandings and action items. Also, a deeper and more complex analytical assessment of the test workload effectiveness can be determined. For example, a test workload that may have been thought to meet a specific set of customer(s) workload criteria, may see its effectiveness expanded to an even greater degree than previously determined through the use of these additional data points created by embodiments of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instruction.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

As used herein, the articles “a” and “an” preceding an element or component are intended to be nonrestrictive regarding the number of instances (i.e., occurrences) of the element or component. Therefore, “a” or “an” should be read to include one or at least one, and the singular word form of the element or component also includes the plural unless the number is obviously meant to be singular.

As used herein, the terms “invention” or “present invention” are non-limiting terms and not intended to refer to any single aspect of the particular invention but encompass all possible aspects as described in the specification and the claims.

As used herein, the term “about” modifying the quantity of an ingredient, component, or reactant of the invention employed refers to variation in the numerical quantity that can occur, for example, through typical measuring and liquid handling procedures used for making concentrates or solutions. Furthermore, variation can occur from inadvertent error in measuring procedures, differences in the manufacture, source, or purity of the ingredients employed to make the compositions or carry out the methods, and the like. In one aspect, the term “about” means within 10% of the reported numerical value. In another aspect, the term “about” means within 5% of the reported numerical value. Yet, in another aspect, the term “about” means within 10, 9, 8, 7, 6, 5, 4, 3, 2, or 1% of the reported numerical value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
determining, by a processor, at least one workload data point;
determining, by the processor, a formula to utilize to operate on the at least one workload data point; and
operating, by the processor, on the at least one workload data point using the determined formula to create one of a new or additional workload data point to be utilized in a test workload run that compares test workload run data with customer workload data.

2. The computer-implemented method of claim 1 wherein the formula comprises a statistical formula.

3. The computer-implemented method of claim 1 wherein the formula is selected from the group consisting of formulas that determine sums, averages, and percentages.

4. The computer-implemented method of claim 1 wherein the formula takes into account test workload characteristics.

5. The computer-implemented method of claim 1 further comprising storing, by the processor, the one of the new or additional workload data point in one of a database or memory.

6. The computer-implemented method of claim 1 further comprising creating, by the processor, a customer profiling baselines visualization that utilizes the at least one of the new or additional workload data point.

7. The computer-implemented method of claim 6 wherein the created customer profiling baselines visualization utilizes the at least one of the new or additional workload data point together with existing customer data coupled with collected test data.

8. A system comprising:
a processor in communication with one or more types of memory, the processor configured to:
determine at least one workload data point;
determine a formula to utilize to operate on the at least one workload data point; and
operate on the at least one workload data point using the determined formula to create one of a new or additional workload data point to be utilized in a test workload run that compares test workload run data with customer workload data.

9. The system of claim 8 wherein the formula comprises a statistical formula.

10. The system of claim 8 wherein the formula is selected from the group consisting of formulas that determine sums, averages, and percentages.

11. The system of claim 8 wherein the formula takes into account test workload characteristics.

12. The system of claim 8 wherein the processor is further configured to further store the one of the new or additional workload data point in one of a database or memory.

13. The system of claim 8 wherein the processor is further configured to create a customer profiling baselines visualization that utilizes the at least one of the new or additional workload data point.

14. The system of claim 13 wherein the processor is further configured to utilize the at least one of the new or additional workload data point together with existing customer data coupled with collected test data within the created customer profiling baselines visualization.

15. A computer program product comprising:
a non-transitory storage medium readable by a processing circuit and storing instructions for execution by the processing circuit for performing a method comprising:
determining, by a processor, at least one workload data point;
determining, by the processor, a formula to utilize to operate on the at least one workload data point; and
operating, by the processor, on the at least one workload data point using the determined formula to create one of a new or additional workload data point to be utilized in a test workload run that compares test workload run data with customer workload data.

16. The computer program product of claim 15 wherein the formula comprises a statistical formula.

17. The computer program product of claim 15 wherein the formula is selected from the group consisting of formulas that determine sums, averages, and percentages.

18. The computer program product of claim 15 wherein the formula takes into account test workload characteristics.

19. The computer program product of claim 15 further comprising storing, by the processor, the one of the new or additional workload data point in one of a database or memory.

20. The computer program product of claim 15 further comprising creating, by the processor, a customer profiling baselines visualization that utilizes the at least one of the new of additional workload data point together with existing customer data coupled with collected test data.
